(19) United States
(12) Patent Application Publication
(10) Pub. No.: US 2024/0326847 A1
(43) Pub. Date: Oct. 3, 2024

(54) LOCALIZATION INITIALIZATION OF AN AUTONOMOUS VEHICLE

(71) Applicant: GM Cruise Holdings LLC, San Francisco, CA (US)

(72) Inventors: Vincent P. Kee, San Francisco, CA (US); Michael Harville, San Carlos, CA (US); Rohan Taneja, San Francisco, CA (US); Kummur Anand, Issaquah, WA (US); Michael Rusignola, Burlingame, CA (US); Juan Fasola, San Francisco, CA (US); Luke Petruzzi, San Francisco, CA (US); Shirish Maheshwari, Cedar Park, TX (US); Jonathan Lenoff, Seattle, WA (US); Sashwat Mahapatra, Hayward, CA (US)

(21) Appl. No.: 18/191,671

(22) Filed: Mar. 28, 2023

(51) Int. Cl. B60W 50/04; B60W 60/00; G06T 7/70; G06V 20/56; H04W 4/02

(52) U.S. Cl. CPC B60W 50/045; B60W 60/00; G06T 7/70; G06V 20/56; H04W 4/025; B60W 2420/403; B60W 2556/45

(57) ABSTRACT

Systems and techniques are provided for initializing the localization of an autonomous vehicle (AV) based on sensor data. An example method can include determining a first position of an AV prior to a power cycle, wherein the power cycle begins when the AV is powered off and ends when the AV is powered on; receiving, after the power cycle, sensor data from one or more sensors of the AV, the sensor data comprising image data; and in response to a determination that the AV has completed the power cycle, determining, based on image data from one or more sensors of the AV, whether a second position of the AV after the power cycle matches the first position of the AV prior to the power cycle.

### BACKGROUND

### 1. Technical Field

The present disclosure generally relates to autonomous vehicles and, more specifically, determining the initialization of localization of an autonomous vehicle based on sensor data.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2 illustrates a diagram of an example localization system architecture, according to some examples of the present disclosure;

FIG. 3 illustrates an example timeline for determining an AV position before and after a power cycle, according to some examples of the present disclosure;

FIG. 4 is a flowchart illustrating an example process for initializing localization of an AV, according to some examples of the present disclosure;

FIG. 5 illustrates an example scene in which an AV can determine an AV position after a power cycle based on sensor data, according to some examples of the present disclosure;

FIG. 6 illustrates another example scene in which an AV can determine an AV position after a power cycle based on sensor data, according to some examples of the present disclosure;

FIG. 7 is a flowchart illustrating an example process for determining an AV position after a power cycle based on sensor data for initializing localization, according to some examples of the present disclosure; and

FIG. 8 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

As previously noted, an autonomous vehicle (AV) is a motorized vehicle that does not require a human driver. To enable autonomous driving in a safe, efficient, and reliable manner, an AV must be equipped with accurate localization, which includes the process of determining the precise location and orientation of the vehicle in its environment. To achieve localization, AVs typically rely on a combination of sensors and mapping technologies. For example, various sensors of an AV may collect data about the surrounding environment. This sensor data can be combined with pre-existing maps of the area to determine the vehicle's estimated location and orientation in real time.

Each time a computing system of an AV is powered on, the computing system may need to determine the initial location and orientation of the vehicle relative to a map of the AV, such as a navigation map and/or a map of a scene. Here, the initial location and orientation of the vehicle can refer to the location and orientation of the vehicle when the vehicle was powered off and/or when the vehicle is powered on. Once the vehicle's position (e.g., location and orientation) has been initialized, the vehicle can use localization algorithms to continually update its position as it navigates through the environment. This enables the vehicle to accurately navigate a scene(s), navigate to the vehicle's destination, avoid obstacles, and make informed decisions about its operations based on its surroundings. The initial localization of an AV (e.g., the initial location and orientation of the AV once a computing system of the AV is powered on) can be determined by navigating (e.g., driving) the AV for a sufficient distance (e.g., a threshold distance or a distance until the AV is able to localize itself or collect sufficient information to localize itself) or to a predetermined location to collect sensor data, and comparing the sensor data to a predetermined map so that a computing system of the AV can localize the AV within the predetermined map.

Systems, apparatuses, processes (also referred to as methods), and computer-readable media (collectively referred to as “systems and techniques”) are described herein for determining whether a position of an AV has changed prior to the completion of a power cycle event based on sensor data. For example, the systems and techniques described herein can determine a position of an AV relative to a power cycle event (e.g., before a computing system of an AV is turned off and/or after the computing system of the AV is turned on). Based on sensor data, the systems and techniques described herein can then determine whether the AV has moved during the power cycle event (e.g., while the computing system of the AV is turned off) and/or when the power cycle event is completed (e.g., after the computing system of the AV is turned on). In some examples, the systems and techniques described herein can initialize a localization based on an indication that the AV has moved since the computer system of the AV was turned off and/or based on the position of the AV before and/or after a power cycle event. As such, without having to travel some distance (e.g., autonomously and/or via manual control) and/or without any manual input or intervention, the systems and techniques can allow an AV to initialize a localization of the AV with high confidence (e.g., a threshold confidence) to enable the autonomous engagement/operation of the AV.

In some examples, a power cycle event can include an event where an AV (or computing system or computing devices of an AV) is turned off and then turned back on or an event where the AV (or a computing system of the AV) is turned on (e.g., for a first time or after being turned off). For example, a power cycle event can begin when an AV (or computing system or computing devices of an AV) is powered off and end when the AV (or computing system or computing devices of an AV) is powered on. In some examples, a power cycle event can begin when an AV (or computing system and/or devices of an AV) is powered off, powered down, shut down, turned off, or deactivated. In some cases, the AV may not be capable of localizing itself during a period relative to the power cycle event, such as during the power cycle event and/or any time while the AV is powered off during the power cycle event or before a completion of the power cycle event. A power cycle event can end or complete when an AV (or computing system and/or devices of an AV) is powered on, powered up, turned on, or activated.

In some examples, the systems and techniques described herein can determine a first position of an AV prior to a power cycle event. For example, as an AV navigates through a driving environment, the AV can collect sensor data, which can be used to localize the vehicle in real-time, for example at every second or tick. In some examples, localization may include determining geolocation/geographic information such as coordinates (e.g., longitude, latitude, and elevation), an orientation of the AV (e.g., a direction of travel, a pose of the AV, an angular orientation of the AV, a heading of the AV, etc.), a speed of the AV, a position (e.g., location and/or orientation) of the AV relative one or more reference points and/or objects in a scene, etc. Such information can be determined based on sensor data captured by various sensors of the AV. For example, an AV can utilize navigation sensors such as Global Navigation Satellite System (GNSS)/Global Positioning System (GPS) receivers and Inertial Measurement Units (IMUs). The systems and techniques described herein can determine and/or save the position of an AV before a power cycle event occurs (e.g., when an AV is powered off) so that the information relating to the saved position of the AV is available when the power cycle is completed (e.g., when the AV is powered back on).

In some aspects, the systems and techniques described herein can determine, after a completion of a power cycle event, whether the first position of an AV (e.g., the position of the AV prior to a completion of a power cycle event) has changed or not based on sensor data. For example, the systems and techniques described herein can determine that an AV has completed the power cycle event (e.g., an AV (or computing system or devices are) turned back on). In response to determining that a power cycle event is completed, an AV can determine whether the first position of the AV prior to the power cycle event has changed based on sensor data (e.g., measurements, image data, and/or other sensor data). If the position of the AV has not changed, the systems and techniques can use the position of the AV that was logged or saved prior to the beginning of the power cycle event to localize the vehicle after the completion of the power cycle event.

In some examples, the systems and techniques can determine any change in the position of an AV after the completion of a power cycle event based on one or more checks. For example, the systems and techniques can perform a preliminary check based on sensor data. The preliminary check can roughly estimate any change in the position of an AV. To illustrate, the preliminary check can generate a preliminary estimate of a change in position of the AV based on sensor data. Non-limiting examples of sensor data for the preliminary check may include a signal from a GNSS/GPS receiver, a signal from a cellular base station or a wireless access point, a signal from an infrared sensor, a signal from an acoustic sensor (e.g., ultrasonic sensor), one or more odometer measurements, one or more wheel encoder measurements, one or more measurements from an inertial measurement unit (IMU), a signal from an ultra-wideband (UWB) sensor, a signal from a light detection and ranging (LIDAR) sensor, a signal from a radio detection and ranging (RADAR) sensor, a signal from a camera sensor, and/or any other sensor. In some examples, the preliminary check can be performed based on sensor data descriptive of one or more reference markers (e.g., one or more fiducial markers, one or more reference objects, etc.) in the scene.

In some cases, if the preliminary check is satisfied, the systems and techniques can perform a granular check to determine whether the position of an AV has changed or not. For example, the systems and techniques can use image data such as camera data or LIDAR data (e.g., point cloud data) to ensure that the AV is at the same position or within a threshold precision, such as at the centimeter level or any other threshold precision. As an illustrative example, the systems and techniques can determine, based on the image data, the respective position of the AV after the power cycle event relative to one or more reference points within a scene and compare a pre-power cycle position of an AV with the respective position of the AV after the power cycle event. In some aspects, the systems and techniques may compare a set of LIDAR data associated with a pre-power cycle position of an AV and a set of LIDAR data captured after the completion of the power cycle event using an Iterative Closest Point (ICP) algorithm to determine any change in the position of the AV.

In some cases, the systems and techniques can facilitate or control the localization initialization of an AV based on a determination of whether the position of an AV has changed (e.g., whether an AV has moved prior to a completion of a power cycle event). For example, based on the determination of whether a position of an AV has changed, the systems and techniques can use the saved localization information (e.g., saved location and orientation of an AV) to localize the AV. If an AV has been localized with high confidence before the AV is powered down, the systems and techniques can determine use the localization information to initialize localization with confidence after the AV is powered back on and enable the autonomous engagement of an AV without any manual intervention.

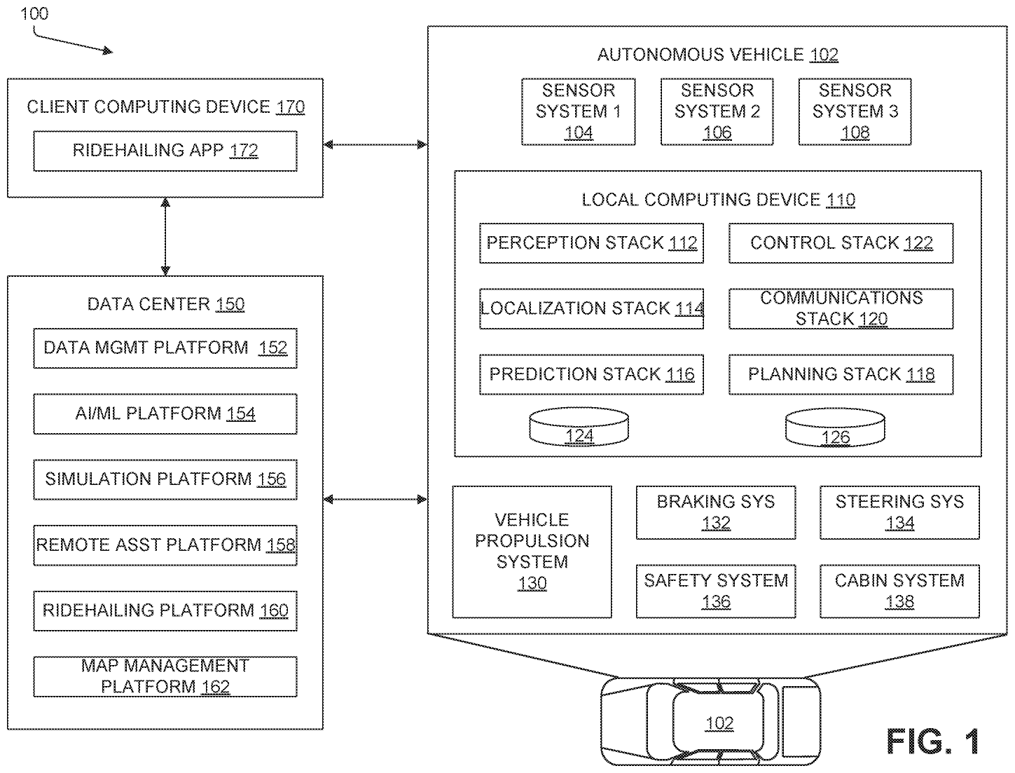

Examples of the systems and techniques described herein are illustrated in FIG. 1 through FIG. 8 and described below.

In some examples, the systems and techniques described herein for initializing localization of an autonomous vehicle (AV) based on sensor data can be implemented by an AV in an AV environment. FIG. 1 is a diagram illustrating an example AV environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 (e.g., client application) to enable passengers to view the AV 102 in transit en route to a pick-up or drop-off location, and so on.

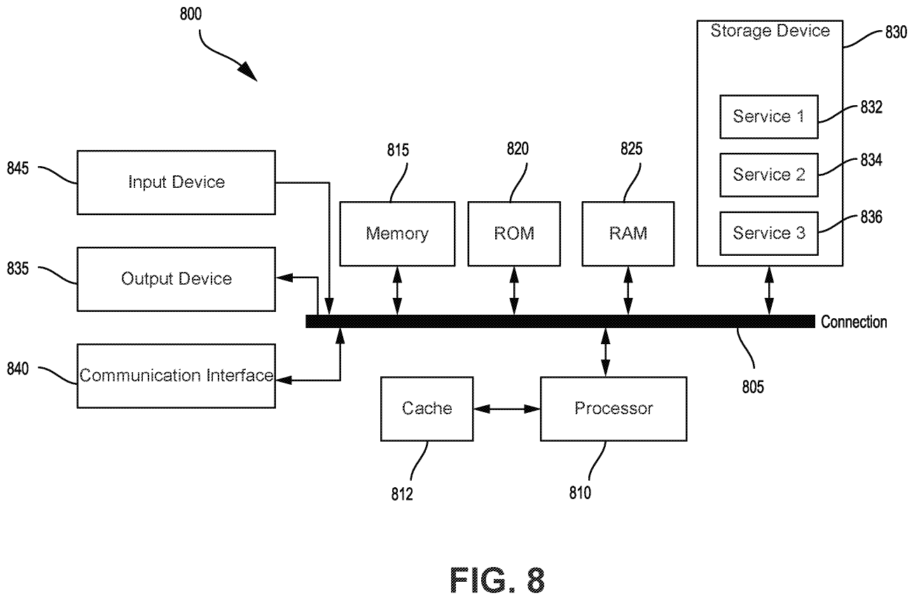

While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 8.

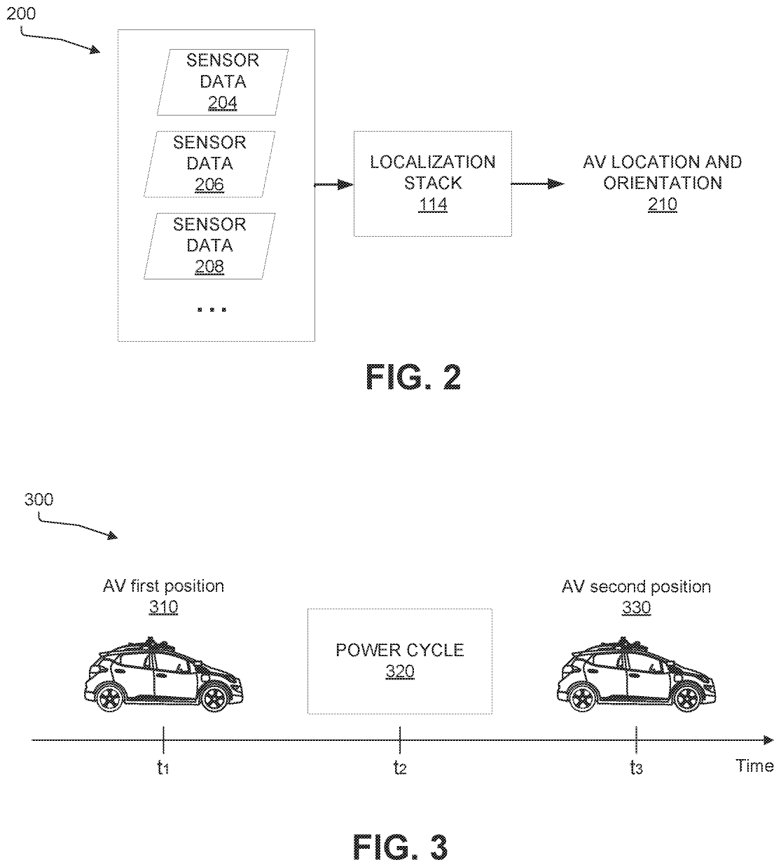

FIG. 2 illustrates a diagram of an example localization system architecture 200, according to some examples of the present disclosure. As previously described with respect to FIG. 1, localization stack 114 is configured to determine the position and orientation (pose) of an AV (e.g., AV 102) based on various methods from multiple systems. For example, various sensors (e.g., sensor systems 104-108 as illustrated in FIG. 1) can generate sensor data 204-208, which may be descriptive of the scene or the surrounding environment of AV 102. For instance, sensor data 204-208 can be collected by one or more sensors (e.g., sensor systems 104-108) including IMUs, camera sensors, LIDAR sensors, infrared (IR) sensors, RADAR sensors, GPS receivers, odometers, wheel encoders, engine sensors, speedometers, tachometers, odometers, altimeters, tilt sensors, and so forth. Based on a combination of sensor data 204-208, localization stack 114 can estimate the AV's location 210, relative to a map or a previously established reference frame. In some examples, localization stack 114 can integrate sensor data 204-208 with motion models and sensor models to estimate the AV's orientation (pose) 210 over time. As follows, AV location and orientation 210 can be used by the AV's control system to navigate and make decisions about its movement.

FIG. 3 illustrates an example timeline 300 showing an example reference time for determining a change in an AV position after completing a power cycle. As shown, an AV (e.g., AV 102) is positioned at AV first position 310 at time t₁ in timeline 300. At time t₂, the AV experiences power cycle 320 (also referred to as a power cycling or a power cycle event). At time t₃, after power cycle 320, the AV is positioned at AV second position 330. In some examples, the systems and techniques of the present disclosure can determine whether AV first position 310 prior to power cycle 320 matches AV second position 330 after power cycle 320.

In some examples, AV first position 310 at time t₁ can be determined prior to power cycle 320. For example, AV first position 310 (e.g., location and orientation) can be determined based on a combination of sensor data and map data as described above with respect to FIG. 2. Localization stack 114 can determine AV first position 310 (similar to AV location and orientation 210) by estimating the AV's location relative to a map or a previously established reference frame (e.g., based on sensor data and map data such as a high-definition (HD) map) and estimating the AV's orientation by integrating sensor data with motion models and sensor models. Non-limiting examples of sensor data that can be used to estimate or determine AV first position 310 can include image data (e.g., a still image, a video frame, etc.), a point cloud or point cloud data, one or more measurements, acoustic data, one or more frames, a sensor map (e.g., a depth map, a TOF sensor map, a heat map, etc.), a GNSS/GPS signal, an output signal (e.g., a RADAR signal, a distance or proximity sensor signal, etc.), a WIFI environment map (e.g., a WIFI heat map, etc.), a wave or pulse (e.g., a sound wave, etc.), a distance or proximity sensor output, an IR sensor output, or any other applicable sensor output.

In some aspects, AV first position 310 prior to power cycle 320 can be logged, saved, or stored at time t₁. For example, the systems and techniques of the present disclosure (e.g., localization stack 114 as illustrated in FIG. 1) can log, save, or store AV first position 310 prior to power cycle 320 so that the position information relating to AV first position 310 can be available after completion of power cycle 320 at time t₂.

As shown in FIG. 3, power cycle 320 occurs at time t₂ in timeline 300. In some aspects, power cycle 320 can include an event where an AV (e.g., AV 102) or computing system and/or devices of an AV have been off or offline. For example, power cycle 320 begins when an AV is turned off, suspended, powered down, shut down, deactivated, or becomes offline and ends when the AV is turned on, unsuspended, powered up, activated, or becomes online. In some examples, power cycle 320 can be triggered by a remote assistance system (e.g., a remote operator). For example, a remote assistance system may suspend the operations of an AV (or a computing system or computing devices of an AV) for safety reasons. In some examples, power cycle 320 can be triggered autonomously for system checks. In some examples, power cycle 320 can be triggered when an AV experiences a failure event such as a collision, a system breakdown/failure, a battery failure, etc.

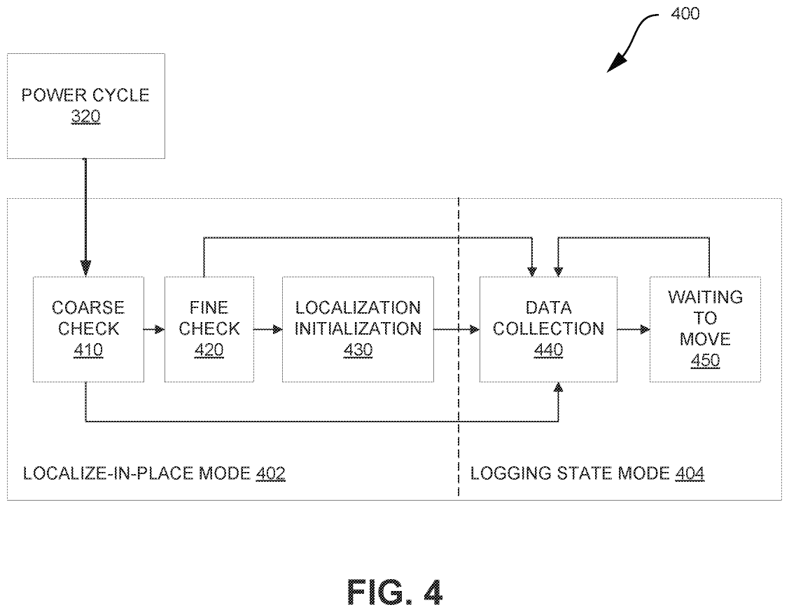

As previously noted, each time an AV (or computing system and/or devices of an AV) completes power cycle 320, the AV (via a localization system such as localization stack 114 as illustrated in FIG. 1) would need to know the location and orientation of the AV (e.g., AV second position 330) relative to a map to localize the AV. In some examples, the systems and techniques of the present disclosure can localize the AV (or initialize the localization of the AV) based on a determination of whether AV second position 330 after the completion of power cycle 320 matches AV first position 310 prior to power cycle 320. Without having to drive an AV to a predetermined location (e.g., a location within a predetermined map), the systems and techniques can determine whether a position of an AV has changed or not after a power cycle and localize the AV based on the pre-power cycle position of the AV if the position of the AV has not changed. Details on how the systems and techniques determine whether AV first position 310 matches AV second position 330 are provided below in relation to FIG. 4.

FIG. 4 is a flowchart illustrating an example process 400 for initializing the localization of an AV. Example process 400 can be initiated by the completion of power cycle 320. In some cases, process 400 can include localize-in-place mode 402 and logging state mode 404. In some examples, localize-in-place mode 402 comprises steps of coarse check 410, fine check 420, and localization initialization 430. For example, in localize-in-place mode 402, an AV can perform checks (e.g., coarse check 410 and/or fine check 420) based on sensor data to ensure that an AV is in the same position after a power cycle. In some examples, logging state mode 404 comprises steps of data collection 440 and waiting to move 450. For example, in logging state mode 404, an AV can log the relevant data relating to an AV position so that the AV position can be used to initialize localization of the AV once the data is logged.

In some examples, in response to a determination that an AV (e.g., AV 102) has completed power cycle 320, the AV can engage in localize-in-place mode 402. For example, in response to determining that power cycle 320 has been completed, the systems and techniques of the present disclosure can proceed to coarse check 410, which comprises one or more coarse or preliminary checks based on sensor data such as a signal from GNSS/GPS receivers, a signal from a cellular base station or a wireless access point, one or more odometer measurements, one or more wheel encoder measurements, one or more measurements from an IMU, a signal from a UWB sensor, and so on. In some examples, coarse check 410 can be based on one or more fiducial markers placed in the scene or the surrounding environment of the AV. The systems and techniques can leverage multiple available signals and measurements (e.g., various sensor data from different sensor modalities) to increase the confidence of coarse check 410.

At coarse check 410, the systems and techniques described herein can estimate a position of an AV (e.g., AV second position 330 as illustrated in FIG. 3) based on a signal transmitted from satellites to determine whether a position of an AV prior to a power cycle matches a position of the AV after the completion of the power cycle. For example, the systems and techniques can estimate a position of an AV using signals from GNSS/GPS receiver(s) to determine an estimated absolute geographical location (e.g., a latitude, longitude and/or altitude). In some examples, the systems and techniques can compare the estimated position of an AV based on GNSS/GPS signals against the AV position that was logged/saved before a power cycle (e.g., AV first position 310) to determine any change in a position. In some aspects, the systems and techniques can determine whether the change (or the degree of difference between the estimated position based on GNSS/GPS signals and the pre-power cycle logged position. In some examples, if the change is below a predetermined threshold for a position change, the systems and techniques can determine that the coarse check (based on GNSS/GPS signals) is satisfied and proceed to fine check 420.

In some aspects, at coarse check 410, the systems and techniques (e.g., localization stack 114) can use one or more odometer readings to determine whether a position of an AV has changed at its resolution (e.g., 20-50 meters) prior to the completion of a power cycle. For example, the systems and techniques can receive a first set of odometer data associated with a position of an AV prior to a power cycle (e.g., AV first position 310 as illustrated in FIG. 3) or a measurement captured by an odometer of an AV prior to a power cycle. The systems and techniques can receive a second set of odometer data after a power cycle or a measurement captured by an odometer of an AV after a power cycle is completed. As follows, the systems and techniques can compare the first and second sets of odometer data captured before and after the power cycle, for example, to determine a difference between the odometer measurements. In some examples, if the difference between the odometer reading before a power cycle (or the odometer reading associated with AV first position 310) and the odometer reading measured after the power cycle is below a predetermined threshold for an odometer measurement, the systems and techniques can determine that the coarse check based on odometer measurements is satisfied and proceed to fine check 420.

In some cases, at coarse check 410, the systems and techniques (e.g., localization stack 114) can use wheel encoder data to determine whether a position of an AV has changed prior to the completion of a power cycle. For example, the systems and techniques can receive a first set of wheel encoder data captured by a wheel encoder of an AV prior to a power cycle (e.g., a wheel encoder data associated with AV first position 310). After a power cycle is completed, the systems and techniques can receive a second set of wheel encoder data captured by the wheel encoder after the power cycle. As follows, the systems and techniques can compare the first and second sets of wheel encoder data captured before and after the power cycle, for example, to determine a difference between the wheel encoder measurements. In some examples, if the difference between the wheel encoder measurement before the power cycle and the wheel encoder measurement after the power cycle is below a predetermined threshold for a wheel encoder measurement, the systems and techniques can determine that the coarse check based on wheel encoder measurements is satisfied and proceed to fine check 420.

In some examples, if an AV is equipped with cellular and/or Wi-Fi capabilities, the systems and techniques can use a signal from a cellular base station or a wireless access point at coarse check 410, to determine a change in a position of an AV after a power cycle. For example, the systems and techniques can estimate a location of an AV (e.g., AV second position 330 as illustrated in FIG. 3) based on a signal from a base station to determine a change in a position of an AV before and after a power cycle. In another example, the systems and techniques can detect a wireless signal from a wireless access point at a location associated with the AV prior to a power cycle. Also, the systems and techniques can detect a wireless signal from the same wireless access point after the power cycle. As such, based on the wireless signal detection from the same wireless access point after the power cycle, the systems and techniques may determine that the AV is within a region comprising the location associated with the AV prior to the power cycle.

In some aspects, at coarse check 410, the systems and techniques can use IMU measurements to determine whether a position of an AV prior to a power cycle (e.g., AV first position 310) has changed after the power cycle is completed. For example, the systems and techniques can receive IMU data associated with the position of an AV prior to a power cycle (e.g., AV first position 310 as illustrated in FIG. 3). After the completion of the power cycle, the systems and techniques can receive IMU data captured by an IMU sensor of the AV (e.g., linear acceleration measured by an accelerometer within the IMU sensor and/or angular velocity measured by a gyroscope within the IMU sensor) to compare with the IMU data associated with the position of an AV prior to the power cycle. As follows, the systems and techniques can, based on the comparison between the IMU data associated with the position of an AV prior to a power cycle and the IMU data captured by the IMU sensor after the completion of the power cycle, determine whether the orientation of the AV has changed after the completion of the power cycle. In some examples, the systems and techniques can determine the difference between the orientation of the AV prior to the power cycle and the orientation of the AV after the power cycle and compare the difference against a threshold for an IMU measurement. If the difference is below the predetermined threshold, the systems and techniques can determine that the coarse check based on IMU measurements is satisfied and proceed to fine check 420.

In some examples, at coarse check 410, the systems and techniques can use sensor data associated with one or more fiducial markers or scene features (e.g., static objects) that may be present in the scene to determine whether a position of an AV prior to a power cycle (e.g., AV first position 310) matches a position of an AV after the power cycle (e.g., AV second position 330). For example, the systems and techniques can identify one or more fiducial markers associated with a position of an AV prior to a power cycle (e.g., Quick Response (QR) codes). After the power cycle, the systems and techniques can determine, based on sensor data that is captured after the power cycle is completed, whether the same fiducial marker(s) that may be indicative of a location and/or position of the AV is present in the scene. In some examples, the scene features/objects that can be leveraged for determining whether a position of an AV has changed or not include, for example without limitation, ground markers, a parking stall number, mile markers, traffic signs, street signs, and so on. If the systems and techniques determine whether the fiducial marker(s) or scene features/objects associated with a position of an AV prior to a power cycle match the fiducial marker(s) or scene features/objects captured by one or more sensors of the AV after the power cycle is completed, the systems and techniques can determine that the coarse check has been satisfied and proceed to fine check 420.

In some aspects, in response to determining that coarse check 410 is satisfied, process 400 can proceed to fine check 420, which may comprise one or more fine-grained checks based on image data, ICP algorithm, etc. For example, in response to determining that coarse check 410 is satisfied, the systems and techniques can proceed to fine check 420 and use sensor data captured by a camera sensor or a LIDAR sensor to determine whether a position of an AV prior to a power cycle (e.g., AV first position 310 as illustrated in FIG. 3) has been changed after the completion of the power cycle.

In some cases, at fine check 420, image data captured by a camera sensor of an AV (e.g., AV 102) can be used to extract relevant features (e.g., scene features and/or objects, road features that may be present in the scene) after the completion of a power cycle and match them to the scene captured at the time of logging or saving the pre-power cycle AV position (e.g., AV first position 310). For example, the systems and techniques can determine, based on the image data captured by an image sensor (e.g., a camera) of an AV after the power cycle, the respective position of the AV relative to one or more reference points within the scene that are depicted in the image data. As follows, the systems and techniques can determine whether the position of the AV prior to the power cycle matches the respective position of the AV by matching the reference points within the scene that may be depicted in the image data to corresponding reference points within the scene captured at the time of logging or saving the position of the AV prior to the power cycle. In some examples, if the position of the AV prior to the power cycle matches the respective position of the AV after the power cycle (e.g., the reference points in the image data captured after the power cycle perfectly match or correspond to the reference points within the scene captured prior to the power cycle), the systems and techniques can determine that fine check 420 is satisfied and the position of the AV has not changed.

In some examples, the systems and techniques can match the extracted features to map data associated with the AV position prior to the power cycle (e.g., a predetermined map that was used to determine AV first position 310). For example, the systems and techniques can pinpoint the pre-power cycle AV position on a map that is descriptive of the scene/surrounding environment. Further, the systems and techniques can match the features that are extracted from image data captured after the completion of the power cycle to the map to determine whether the pre-power cycle AV position has changed (or whether the AV has moved before the power cycle is completed or whether AV first position 310 matches AV second position 330).

In some aspects, at fine check 420, the systems and techniques can use sensor data captured by a LIDAR sensor of an AV after the completion of a power cycle to determine whether a position of the AV has changed. For example, the systems and techniques of the present disclosure (e.g., localization stack 114) can receive LIDAR sensor data associated with a position of an AV prior to a power cycle (e.g., AV first position 310). After the power cycle, the systems and techniques can receive LIDAR sensor data captured by the LIDAR sensor of the AV. As follows, a first set of LIDAR sensor data (e.g., point cloud data) associated with the pre-power cycle AV position and a second set of LIDAR sensor data (e.g., point cloud data) captured after the completion of the power cycle can be compared. For example, the systems and techniques can compare the first set and the second set of LIDAR sensor data using a geometric method (e.g., point cloud alignment such as an ICP algorithm) and/or an intensity-based method (e.g., correlation).

In some cases, point clouds of the first set of LIDAR sensor data can be compared to corresponding point clouds of the second set of LIDAR sensor data using an ICP algorithm. For example, the ICP algorithm can be used to match, for each point in the first set of LIDAR sensor data that is captured before the beginning of the power cycle, the closest point in the second set of LIDAR sensor data that is captured after the completion of the power cycle to estimate the combination of rotation and translation between the first set and the second set of LIDAR sensor data. In some examples, if an output of the ICP algorithm shows zero rotation and/or translation, the systems and techniques of the present disclosure can determine that a position of an AV that has been logged or saved prior to the power cycle has not changed during the power cycle and after the power cycle and determine that fine check 420 is satisfied.

In some examples, process 400 can proceed to localization initialization 430 In response to determining that fine check 420 is satisfied. At localization initialization 430, the systems and techniques can initialize the localization of an AV based on the saved position of an AV prior to a power cycle (e.g., AV first position 310 as illustrated in FIG. 3) so that the AV may engage in autonomous operations. For example, if the results of coarse check 410 and fine check 420 indicate that a position of an AV has not changed (e.g., an AV has not moved, or AV first position 310 matches AV second position 330 as illustrated in FIG. 3), localization stack 114 can localize the AV after a power cycle, without any manual intervention, based on the last known position of the AV (e.g., AV first position 310).

In some cases, as an AV is navigating through the scene, the AV may engage in logging state mode 404. In logging state mode 404, the systems and techniques can continuously collect the data for localizing in memory (e.g., storage or database such as an AV operational database 124 as illustrated in FIG. 1) at data collection 440. Once an AV (e.g., AV 102) is fully stopped, a position of the AV can be written to disk. As follows, the logged position of the AV can be used, after a planned or unexpected power cycle, to initialize the localization of the AV. In some examples, the systems and techniques can wait for the AV to move before collecting more data to log the next time the AV fully stops at waiting to move 450.

In some examples, the systems and techniques of the present disclosure can leverage other available data and/or measurements such as sensor data captured by one or more vehicles in a fleet, image data captured by one or more cameras placed in a facility, etc. for coarse check 410 and/or fine check 420. For example, the systems and techniques can receive sensor data captured by one or more vehicles in the same fleet or sensors placed in a facility that may be indicative of a position of an AV and use the sensor data for coarse check 410 and/or fine check 420.

When an AV is located at a multi-level garage, a signal from GPS receivers may not accurately determine the position of the AV (e.g., longitude, latitude, and elevation). As follows, the systems and techniques of the present disclosure can leverage sensor data and measurements from multiple sources or in different methods to provide high accuracy and confidence in determining whether a position of an AV has changed after a power cycle.

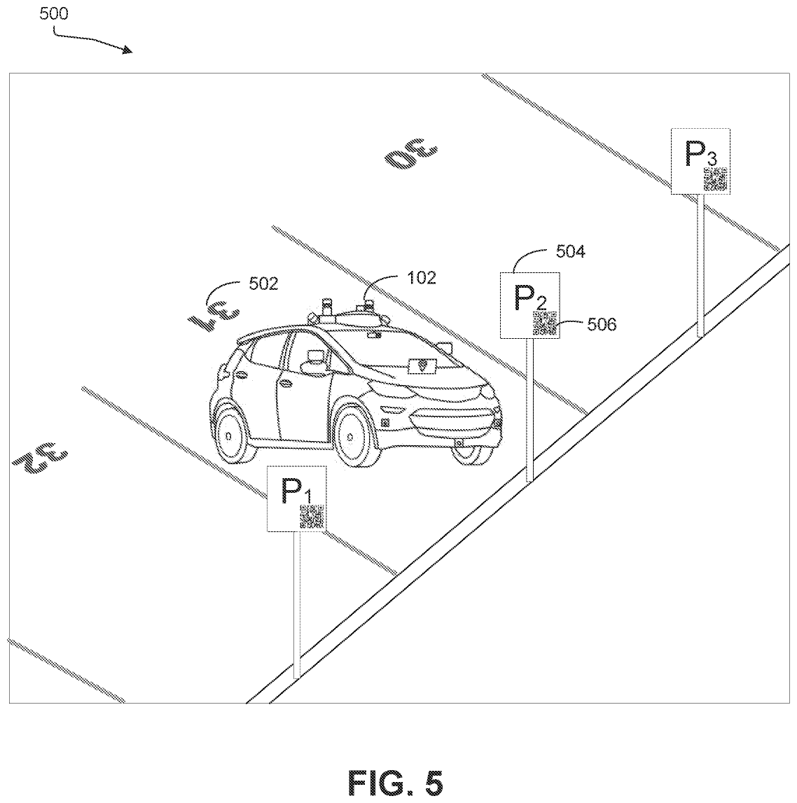

FIG. 5 illustrates an example scene 500 of determining, based on sensor data, whether an AV position has changed after a power cycle. As shown, example scene 500 includes AV 102, which is parked at a parking lot that has a ground marker 502 as a parking stall number, a parking lot sign 504, and a fiducial marker 506 (e.g., QR code). In some examples, when AV 102 parks at the parking lot, the systems and techniques can receive sensor data captured by various sensors (e.g., sensor systems 104-108) of AV 102 before AV 102 is turned off. In some examples, the sensor data can comprise a signal from GNSS/GPS receivers, a signal from a cellular base station or a wireless access point, one or more odometer measurements, one or more wheel encoder measurements, one or more measurements from an IMU, a signal from a UWB sensor, image data collected by one or more image sensors of AV 102, and so on. Based on the sensor data (e.g., sensor data 204-208), localization stack 114 can determine a position of AV 102 (e.g., AV location and orientation 210) and log or save the position of AV 102 before AV 102 is turned off.

In some examples, when AV 102 is turned on, localization stack 114 can receive sensor data that may be descriptive of scene 500. For example, various sensors of AV 102 can capture sensor data, after AV 102 is turned back on, which includes a signal from GNSS/GPS receivers, a signal from a cellular base station or a wireless access point, one or more odometer measurements, one or more wheel encoder measurements, one or more measurements from an IMU, a signal from a UWB sensor, image data collected by one or more image sensors of AV 102, and so on. As follows, localization stack 114 can determine, based on the sensor data, whether an AV has moved since the position of AV 102 is logged or saved.

In some examples, localization stack 114 can determine whether AV 102 has moved or the logged/saved position of AV 102 has changed based on the sensor data that is captured after AV 102 is turned back on. For example, localization stack 114 can determine a location or roughly estimate a position of AV based on fiducial marker 506. Localization stack 114 can match fiducial marker 506 captured or scanned before and after a power cycle (e.g., fiducial marker 506 captured before AV 102 is turned off and fiducial marker 506 captured after AV 102 is turned back on) and determine whether an AV has moved since the position of AV 102 is logged or saved.

In some examples, localization stack 114 can use image data captured by a camera sensor of AV 102 or LIDAR data (e.g., point cloud data) captured by a LIDAR sensor of AV 102 after AV 102 is turned back on. For example, localization stack 114 can extract, from image data, one or more static features within scene 500 such as ground marker 502, parking lot sign 504, etc. Localization stack 114 can determine the respective position of AV 102 relative to the feature(s) and compare the respective position with the position of AV 102 that was saved before AV 102 is turned off to determine whether the logged/saved position of AV 102 matches the respective position of AV 102 that is determined after AV 102 is turned back on. In another example, localization stack 114 can compare the LIDAR data captured after AV 102 is turned on against LIDAR data captured before AV 102 is turned off using an ICP algorithm to determine whether the position of AV 102 has changed since the last time the position of AV 102 is logged/saved.

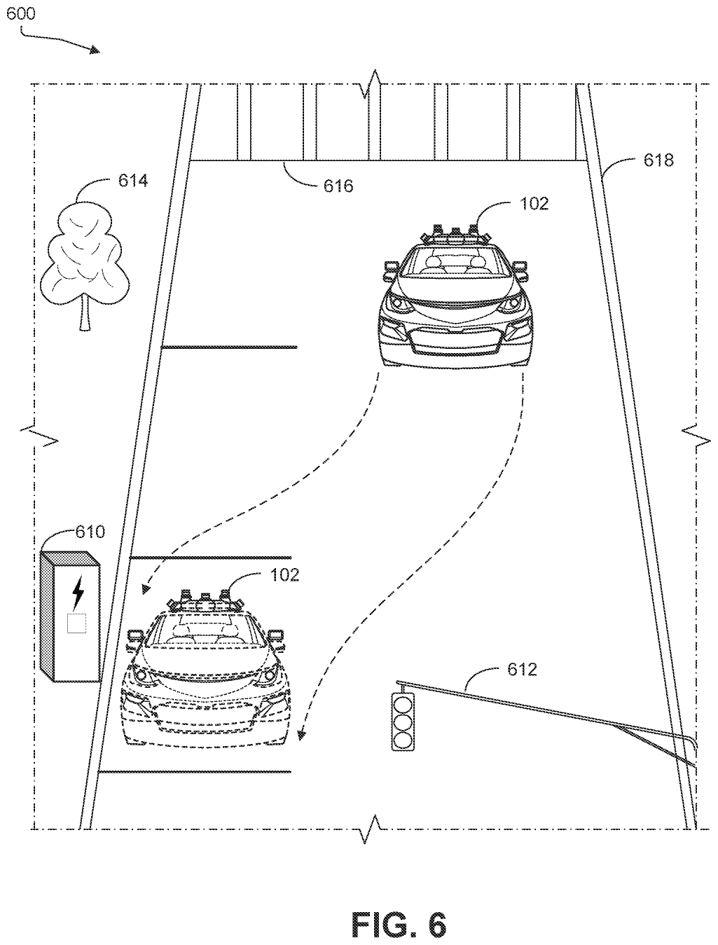

FIG. 6 illustrates an example scene 600 of determining, based on sensor data, whether an AV position has changed after a power cycle. In the illustrative example of FIG. 6, example scene 600 includes AV 102 that is located on the road and then moved or parked near charging station 610. Example scene 600 further includes traffic light 612, tree 614, crosswalk 616, curb 618. In the illustrative example of FIG. 6, AV 102 is navigating in scene 600 prior to a power cycle and is parked near charging station 610 after the power cycle. For example, as AV 102 is navigating in scene 600, localization stack 114 of AV 102 can determine and log a position of AV 102. From then on, AV 102 experiences a power cycle (e.g., computing system or devices of AV 102 are shut down) and is positioned near charging station 610 when AV 102 is powered on.

In some examples, localization stack 114 can determine, based on sensor data, whether AV 102 has moved since AV 102 was powered off or whether a position of AV 102 is different when AV 102 is powered back on than a last-saved position of AV 102. For example, localization stack 114 can receive sensor data captured by one or more sensors of AV 102 after AV 102 is turned on. Localization stack 114 can perform non-ICP checks (e.g., coarse check 410 as illustrated in FIG. 4) and/or ICP checks (e.g., fine check 420 as illustrated in FIG. 4) to determine the change in the position of AV 102. For example, localization stack 114 can determine a position of AV 102 relative to static objects in scene 600 such as traffic light 612, tree 614, crosswalk 616, curb 618, etc. when AV 102 is turned on while navigating on the road. Localization stack 114, after AV 102 is turned off and turned back on, can extract the static objects from image data captured after AV 102 is turned back on, to determine the respective position of AV relative to those static objects. As follows, localization stack 114 can match the position of AV 102 before AV 102 is turned off and the respective position of AV 102 after AV 102 is turned back on by matching corresponding extracted features in scene 600. Based on the comparison, localization stack 114 can determine whether AV 102 has moved since the position of AV 102 is logged/saved while navigating on the road.

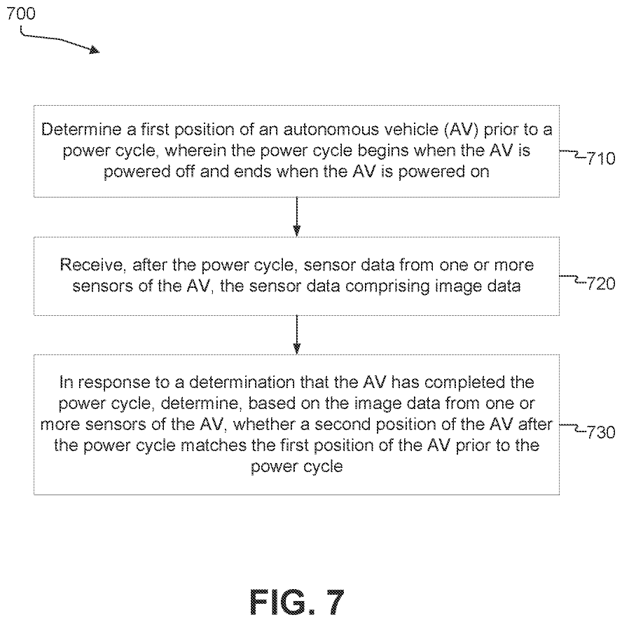

FIG. 7 is a flowchart illustrating an example process 700 for determining an AV position after a power cycle based on sensor data for initializing localization. Although the example process 700 depicts a particular sequence of operations, the sequence may be altered without departing from the scope of the present disclosure. For example, some of the operations depicted may be performed in parallel or in a different sequence that does not materially affect the function of process 700. In other examples, different components of an example device or system that implements process 700 may perform functions at substantially the same time or in a specific sequence.

At block 710, process 700 includes determining a first position of an AV prior to a power cycle, wherein the power cycle begins when the AV is powered off and ends when the AV is powered on. For example, localization stack 114 can determine an AV first position 310 prior to power cycle 320, which begins when AV 102 is powered off and ends when AV 102 is powered on. As noted, a power cycle can include an event where an AV (or computing system or devices of an AV) is turned off, suspended, or incapable of logging a position of the AV and then, turned back on, or unsuspended. In some examples, a power cycle can be planned or scheduled such as for parking or charging. In some examples, an AV may experience an unexpected or unforeseen power cycle, for example, due to system failures or malfunctioning, low power, battery, or disk space, collisions, etc.

At block 720, process 700 includes receiving, after the power cycle, sensor data from one or more sensors of the AV, the sensor data comprising image data. For example, localization stack 114, after power cycle 320, receives sensor data 204-208 from one or more sensors of AV 102 (e.g., sensor systems 104-108). In some cases, sensor data 204-208 comprise image data, which is captured by an image sensor of AV 102 (e.g., a camera sensor, LIDAR sensor, etc.).

At block 730, process 700 includes in response to a determination that the AV has completed the power cycle, determining, based on the image data from one or more sensors of the AV, whether a second position of the AV after the power cycle matches the first position of the AV prior to the power cycle. For example, in response to a determination that AV 102 has completed power cycle 320, localization stack 114 can determine whether a second position of AV 102 after power cycle 320 matches the first position of AV 102 prior to power cycle 320 based on the image data.

In some examples, localization stack 114 can determine, based on the image data, a respective position of the AV after the power cycle relative to one or more reference points within a scene. The second position of the AV after the power cycle may comprise the respective position of the AV relative to the one or more reference points within the scene that may be depicted in the image data. As follows, localization stack 114 can compare the first position of the AV prior to the power cycle with the second position of the AV after the power cycle. The first position of the AV may comprise an additional respective position of the AV relative to the one or more reference points within the scene.

In some aspects, if localization stack 114 determines that AV second position 330 after power cycle 320 matches AV first position 310 prior to power cycle 320, the systems and techniques described herein can control an operation of AV 102 based on AV first position 310. For example, if localization stack 114 determines that AV first position 310 matches AV second position 330 based on coarse check 410 and fine check 420, localization stack 114 can localize AV 102 based on AV first position 310 and provide the localization information to various systems of AV 102 to control the operation of AV 102 based on AV first position 310.

In some examples, controlling the operation of AV 102 can include navigating AV 102, planning a route of AV 102, and so on. For example, localization stack 114 can localize AV 102 based on AV first position 310 and provide the localization information to various systems of AV 102 such as planning stack 118, a navigation stack, or any other system that may use the localization information to control the operation of AV 102.

In some examples, if localization stack 114 determines that AV second position 330 after power cycle 320 does not match AV first position 310 prior to power cycle 320, the systems and techniques can determine a location and orientation of AV 102 after power cycle 320 based on sensor data captured by one or more sensors (e.g., sensor systems 104-108) of AV 102. For example, the sensor data can include at least one of a signal from a GPS receiver, a signal from a RADAR sensor, a signal from a LIDAR sensor, one or more measurements from an IMU, a signal from an acoustic sensor, a signal from a time-of-flight sensor, etc.

FIG. 8 illustrates an example processor-based system with which some aspects of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communication interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some examples, a hardware service that performs a particular function can include the software component stored in a computer-readable medium in connection with the necessary hardware components, such as processor 810, connection 805, output device 835, etc., to carry out the function.

Examples within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: determine a first position of an autonomous vehicle (AV) prior to a power cycle, wherein the power cycle begins when the AV is powered off and ends when the AV is powered on; receive, after the power cycle, sensor data from one or more sensors of the AV, the sensor data comprising image data; and in response to a determination that the AV has completed the power cycle, determine, based on the image data from one or more sensors of the AV, whether a second position of the AV after the power cycle matches the first position of the AV prior to the power cycle.

Aspect 2. The system of Aspect 1, wherein determining whether the second position of the AV after the power cycle matches the first position of the AV prior to the power cycle comprises: determining, based on the image data, a respective position of the AV after the power cycle relative to one or more reference points within a scene, wherein the second position of the AV comprises the respective position of the AV relative to the one or more reference points within the scene, the one or more reference points within the scene being depicted in the image data; and comparing the first position of the AV prior to the power cycle with the second position of the AV after the power cycle, wherein the first position of the AV comprises an additional respective position of the AV relative to the one or more reference points within the scene.

Aspect 3. The system of Aspects 1 or 2, wherein the one or more processors are configured to: in response to determining the second position of the AV after the power cycle matches the first position of the AV prior to the power cycle, control an operation of the AV based on the first position of the AV.

Aspect 4. The system of Aspect 3, wherein controlling the operation of the AV based on the first position of the AV prior to the power cycle comprises at least one of navigating the AV and planning a route of the AV.

Aspect 5. The system of any of Aspects 1 to 5, wherein the one or more processors are configured to: in response to determining the second position of the AV after the power cycle does not match the first position of the AV prior to the power cycle, determine a location and orientation of the AV after the power cycle based on the sensor data, wherein the sensor data further comprises at least one of a signal from a Global Positioning System (GPS), a signal from a Radio Detection and Ranging (RADAR) sensor, a signal from a Light Detection and Ranging (LiDAR) sensor, one or more measurements from an Inertial Measurement Unit (IMU), a signal from an acoustic sensor, and a signal from a time of flight sensor.

Aspect 6. The system of any of Aspects 1 to 6, wherein determining whether the second position of the AV after the power cycle matches the first position of the AV prior to the power cycle comprises: determining, based on at least one of odometer data and wheel encoder data, whether the second position of the AV after the power cycle matches the first position of the AV prior to the power cycle.

Aspect 7. The system of Aspect 6, wherein determining whether the second position of the AV after the power cycle matches the first position of the AV prior to the power cycle comprises: receiving a first set of odometer data captured by an odometer of the AV prior to the power cycle; receiving a second set of odometer data captured by the odometer of the AV after the power cycle; comparing the first set of odometer data captured by the odometer of the AV prior to the power cycle and the second set of odometer data captured by the odometer of the AV after the power cycle; and based on the comparing of the first set of odometer data captured by the odometer of the AV prior to the power cycle and the second set of odometer data captured by the odometer of the AV after the power cycle, determining whether the second position of the AV after the power cycle matches the first position of the AV prior to the power cycle.

Aspect 8. The system of Aspect 6, wherein determining whether the second position of the AV after the power cycle matches the first position of the AV prior to the power cycle comprises: receiving a first set of wheel encoder data captured by a wheel encoder of the AV prior to the power cycle; receiving a second set of wheel encoder data captured by the wheel encoder of the AV after the power cycle; comparing the first set of wheel encoder data captured by the wheel encoder of the AV prior to the power cycle and the second set of wheel encoder data captured by the wheel encoder of the AV after the power cycle; and based on the comparing of the first set of wheel encoder data captured by the wheel encoder of the AV prior to the power cycle and the second set of wheel encoder data captured by the wheel encoder of the AV after the power cycle, determining whether the second position of the AV after the power cycle matches the first position of the AV prior to the power cycle.

Aspect 9. The system of any of Aspects 1 to 8, wherein the one or more processors are configured to: detect a first wireless signal from a wireless access point at a location associated with the AV prior to the power cycle; detect a second wireless signal from the wireless access point after the power cycle; and based on the detecting the second wireless signal from the wireless access point after the power cycle, determine, after the power cycle, the AV is within a region comprising the location associated with the AV prior to the power cycle.

Aspect 10. A method comprising: determining a first position of an autonomous vehicle (AV) prior to a power cycle, wherein the power cycle begins when the AV is powered off and ends when the AV is powered on; receiving, after the power cycle, sensor data from one or more sensors of the AV, the sensor data comprising image data; and in response to a determination that the AV has completed the power cycle, determining, based on the image data from one or more sensors of the AV, whether a second position of the AV after the power cycle matches the first position of the AV prior to the power cycle.

Aspect 11. The method of Aspect 10, wherein determining whether the second position of the AV after the power cycle matches the first position of the AV prior to the power cycle comprises: determining, based on the image data, a respective position of the AV after the power cycle relative to one or more reference points within a scene, wherein the second position of the AV comprises the respective position of the AV relative to the one or more reference points within the scene, the one or more reference points within the scene being depicted in the image data; and comparing the first position of the AV prior to the power cycle with the second position of the AV after the power cycle, wherein the first position of the AV comprises an additional respective position of the AV relative to the one or more reference points within the scene.

Aspect 12. The method of Aspects 10 or 11, further comprising: in response to determining the second position of the AV after the power cycle matches the first position of the AV prior to the power cycle, controlling an operation of the AV based on the first position of the AV.

Aspect 13. The method of Aspect 12, wherein controlling the operation of the AV based on the first position of the AV prior to the power cycle comprises at least one of navigating the AV and planning a route of the AV.

Aspect 14. The method of any of Aspects 10 to 13, further comprising: in response to determining the second position of the AV after the power cycle does not match the first position of the AV prior to the power cycle, determining a location and orientation of the AV after the power cycle based on the sensor data, wherein the sensor data further comprises at least one of a signal from a Global Positioning System (GPS), a signal from a Radio Detection and Ranging (RADAR) sensor, a signal from a Light Detection and Ranging (LiDAR) sensor, one or more measurements from an Inertial Measurement Unit (IMU), a signal from an acoustic sensor, and a signal from a time of flight sensor.

Aspect 15. The method of any of Aspects 10 to 14, wherein determining whether the second position of the AV after the power cycle matches the first position of the AV prior to the power cycle comprises: determining, based on at least one of odometer data and wheel encoder data, whether the second position of the AV after the power cycle matches the first position of the AV prior to the power cycle.

Aspect 16. The method of Aspect 15, wherein determining whether the second position of the AV after the power cycle matches the first position of the AV prior to the power cycle comprises: receiving a first set of odometer data captured by an odometer of the AV prior to the power cycle; receiving a second set of odometer data captured by the odometer of the AV after the power cycle; comparing the first set of odometer data captured by the odometer of the AV prior to the power cycle and the second set of odometer data captured by the odometer of the AV after the power cycle; and based on the comparing of the first set of odometer data captured by the odometer of the AV prior to the power cycle and the second set of odometer data captured by the odometer of the AV after the power cycle, determining whether the second position of the AV after the power cycle matches the first position of the AV prior to the power cycle.

Aspect 17. The method of Aspect 15, wherein determining whether the second position of the AV after the power cycle matches the first position of the AV prior to the power cycle comprises: receiving a first set of wheel encoder data captured by a wheel encoder of the AV prior to the power cycle; receiving a second set of wheel encoder data captured by the wheel encoder of the AV after the power cycle; comparing the first set of wheel encoder data captured by the wheel encoder of the AV prior to the power cycle and the second set of wheel encoder data captured by the wheel encoder of the AV after the power cycle; and based on the comparing of the first set of wheel encoder data captured by the wheel encoder of the AV prior to the power cycle and the second set of wheel encoder data captured by the wheel encoder of the AV after the power cycle, determining whether the second position of the AV after the power cycle matches the first position of the AV prior to the power cycle.

Aspect 18. The method of any of Aspects 10 to 17, further comprising: detecting a first wireless signal from a wireless access point at a location associated with the AV prior to the power cycle; detecting a second wireless signal from the wireless access point after the power cycle; and based on the detecting the second wireless signal from the wireless access point after the power cycle, determining, after the power cycle, the AV is within a region comprising the location associated with the AV prior to the power cycle.

Aspect 19. A non-transitory computer-readable storage medium comprising at least one instruction for causing a computer or processor to perform method according to any of Aspects 10 to 18.

1. A system comprising:
a memory; and
one or more processors coupled to the memory, the one or more processors being configured to:
determine a first position of an autonomous vehicle (AV) prior to a power cycle, wherein the power cycle begins when the AV is powered off and ends when the AV is powered on;
receive, after the power cycle, sensor data from one or more sensors of the AV, the sensor data comprising image data; and
in response to a determination that the AV has completed the power cycle, determine, based on the image data from one or more sensors of the AV, whether a second position of the AV after the power cycle matches the first position of the AV prior to the power cycle.

2. The system of claim 1, wherein determining whether the second position of the AV after the power cycle matches the first position of the AV prior to the power cycle comprises:
determining, based on the image data, a respective position of the AV after the power cycle relative to one or more reference points within a scene, wherein the second position of the AV comprises the respective position of the AV relative to the one or more reference points within the scene, the one or more reference points within the scene being depicted in the image data; and
comparing the first position of the AV prior to the power cycle with the second position of the AV after the power cycle, wherein the first position of the AV comprises an additional respective position of the AV relative to the one or more reference points within the scene.

3. The system of claim 1, wherein the one or more processors are configured to:
in response to determining the second position of the AV after the power cycle matches the first position of the AV prior to the power cycle, control an operation of the AV based on the first position of the AV.

4. The system of claim 3, wherein controlling the operation of the AV based on the first position of the AV prior to the power cycle comprises at least one of navigating the AV and planning a route of the AV.

5. The system of claim 1, wherein the one or more processors are configured to:
in response to determining the second position of the AV after the power cycle does not match the first position of the AV prior to the power cycle, determine a location and orientation of the AV after the power cycle based on the sensor data, wherein the sensor data further comprises at least one of a signal from a Global Positioning System (GPS), a signal from a Radio Detection and Ranging (RADAR) sensor, a signal from a Light Detection and Ranging (LiDAR) sensor, one or more measurements from an Inertial Measurement Unit (IMU), a signal from an acoustic sensor, and a signal from a time of flight sensor.

6. The system of claim 1, wherein determining whether the second position of the AV after the power cycle matches the first position of the AV prior to the power cycle comprises:
determining, based on at least one of odometer data and wheel encoder data, whether the second position of the AV after the power cycle matches the first position of the AV prior to the power cycle.

7. The system of claim 6, wherein determining whether the second position of the AV after the power cycle matches the first position of the AV prior to the power cycle comprises:
receiving a first set of odometer data captured by an odometer of the AV prior to the power cycle;
receiving a second set of odometer data captured by the odometer of the AV after the power cycle;
comparing the first set of odometer data captured by the odometer of the AV prior to the power cycle and the second set of odometer data captured by the odometer of the AV after the power cycle; and
based on the comparing of the first set of odometer data captured by the odometer of the AV prior to the power cycle and the second set of odometer data captured by the odometer of the AV after the power cycle, determining whether the second position of the AV after the power cycle matches the first position of the AV prior to the power cycle.

8. The system of claim 6, wherein determining whether the second position of the AV after the power cycle matches the first position of the AV prior to the power cycle comprises:
receiving a first set of wheel encoder data captured by a wheel encoder of the AV prior to the power cycle;
receiving a second set of wheel encoder data captured by the wheel encoder of the AV after the power cycle;
comparing the first set of wheel encoder data captured by the wheel encoder of the AV prior to the power cycle and the second set of wheel encoder data captured by the wheel encoder of the AV after the power cycle; and
based on the comparing of the first set of wheel encoder data captured by the wheel encoder of the AV prior to the power cycle and the second set of wheel encoder data captured by the wheel encoder of the AV after the power cycle, determining whether the second position of the AV after the power cycle matches the first position of the AV prior to the power cycle.

9. The system of claim 1, wherein the one or more processors are configured to:
detect a first wireless signal from a wireless access point at a location associated with the AV prior to the power cycle;
detect a second wireless signal from the wireless access point after the power cycle; and
based on the detecting the second wireless signal from the wireless access point after the power cycle, determine, after the power cycle, the AV is within a region comprising the location associated with the AV prior to the power cycle.

10. A method comprising:
determining a first position of an autonomous vehicle (AV) prior to a power cycle, wherein the power cycle begins when the AV is powered off and ends when the AV is powered on;
receiving, after the power cycle, sensor data from one or more sensors of the AV; and
in response to a determination that the AV has completed the power cycle, determining, based on the sensor data from one or more sensors of the AV, whether a second position of the AV after the power cycle matches the first position of the AV prior to the power cycle.

11. The method of claim 10, wherein determining whether the second position of the AV after the power cycle matches the first position of the AV prior to the power cycle comprises:
determining, based on the sensor data, a respective position of the AV after the power cycle relative to one or more reference points within a scene, wherein the second position of the AV comprises the respective position of the AV relative to the one or more reference points within the scene, the one or more reference points within the scene being depicted in the sensor data; and
comparing the first position of the AV prior to the power cycle with the second position of the AV after the power cycle, wherein the first position of the AV comprises an additional respective position of the AV relative to the one or more reference points within the scene.

12. The method of claim 10, further comprising:
in response to determining the second position of the AV after the power cycle matches the first position of the AV prior to the power cycle, controlling an operation of the AV based on the first position of the AV.

13. The method of claim 12, wherein controlling the operation of the AV based on the first position of the AV prior to the power cycle comprises at least one of navigating the AV and planning a route of the AV.

14. The method of claim 10, further comprising:
in response to determining the second position of the AV after the power cycle does not match the first position of the AV prior to the power cycle, determining a location and orientation of the AV after the power cycle based on the sensor data, wherein the sensor data further comprises at least one of a signal from a Global Positioning System (GPS), a signal from a Radio Detection and Ranging (RADAR) sensor, a signal from a Light Detection and Ranging (LiDAR) sensor, one or more measurements from an Inertial Measurement Unit (IMU), a signal from an acoustic sensor, and a signal from a time of flight sensor.

15. The method of claim 10, wherein determining whether the second position of the AV after the power cycle matches the first position of the AV prior to the power cycle comprises:
determining, based on at least one of odometer data and wheel encoder data, whether the second position of the AV after the power cycle matches the first position of the AV prior to the power cycle.

16. The method of claim 15, wherein determining whether the second position of the AV after the power cycle matches the first position of the AV prior to the power cycle comprises:
receiving a first set of odometer data captured by an odometer of the AV prior to the power cycle;
receiving a second set of odometer data captured by the odometer of the AV after the power cycle;
comparing the first set of odometer data captured by the odometer of the AV prior to the power cycle and the second set of odometer data captured by the odometer of the AV after the power cycle; and
based on the comparing of the first set of odometer data captured by the odometer of the AV prior to the power cycle and the second set of odometer data captured by the odometer of the AV after the power cycle, determining whether the second position of the AV after the power cycle matches the first position of the AV prior to the power cycle.

17. The method of claim 15, wherein determining whether the second position of the AV after the power cycle matches the first position of the AV prior to the power cycle comprises:
receiving a first set of wheel encoder data captured by a wheel encoder of the AV prior to the power cycle;
receiving a second set of wheel encoder data captured by the wheel encoder of the AV after the power cycle;
comparing the first set of wheel encoder data captured by the wheel encoder of the AV prior to the power cycle and the second set of wheel encoder data captured by the wheel encoder of the AV after the power cycle; and
based on the comparing of the first set of wheel encoder data captured by the wheel encoder of the AV prior to the power cycle and the second set of wheel encoder data captured by the wheel encoder of the AV after the power cycle, determining whether the second position of the AV after the power cycle matches the first position of the AV prior to the power cycle.

18. The method of claim 10, further comprising:
detecting a first wireless signal from a wireless access point at a location associated with the AV prior to the power cycle;
detecting a second wireless signal from the wireless access point after the power cycle; and
based on the detecting the second wireless signal from the wireless access point after the power cycle, determining, after the power cycle, the AV is within a region comprising the location associated with the AV prior to the power cycle.

19. A non-transitory computer-readable medium having stored thereon instructions which, when executed by one or more processors, cause the one or more processors to:
determine a first position of an autonomous vehicle (AV) prior to a power cycle, wherein the power cycle begins when the AV is powered off and ends when the AV is powered on;
receive, after the power cycle, sensor data from one or more sensors of the AV, the sensor data comprising Light Detection and Ranging (LIDAR) data; and
in response to a determination that the AV has completed the power cycle, determine, based on the LIDAR data from one or more sensors of the AV, whether a second position of the AV after the power cycle matches the first position of the AV prior to the power cycle.

20. The non-transitory computer-readable medium of claim 19, wherein determining whether the second position of the AV after the power cycle matches the first position of the AV prior to the power cycle comprises:
determining, based on the LIDAR data, a respective position of the AV after the power cycle relative to one or more reference points within a scene, wherein the second position of the AV comprises the respective position of the AV relative to the one or more reference points within the scene, the one or more reference points within the scene being depicted in the LIDAR data; and
comparing the first position of the AV prior to the power cycle with the second position of the AV after the power cycle, wherein the first position of the AV comprises an additional respective position of the AV relative to the one or more reference points within the scene.
